(19) United States
(12) Patent Application Publication
(10) Pub. No.: US 2011/0001576 A1
(43) Pub. Date: Jan. 6, 2011

(54) POWER AMPLIFIER MODULE

(75) Inventors: Young Ho Lee, Seoul (KR); Sun Young Lee, Seoul (KR); Young Kwon, Thousang Oaks, CA (US)

Correspondence Address: Kathy Manke;Avago Technologies Limited, 4380 Ziegler Road, Fort Collins, CO, 80525, US

(73) Assignee: Avago Technologies Wireless IP (Singapore) Pte. Ltd., Singapore (SG)

(21) Appl. No.: 12/497,601

(22) Filed: Jul. 3, 2009

(51) Int. Cl. H01P 5/18

(52) U.S. Cl. 333/116

(57) ABSTRACT

A power amplifier module comprises a power amplifier disposed in a coreless substrate and a directional coupler disposed in a coreless substrate and connected to the power amplifier.

### BACKGROUND AND SUMMARY

As many electronic devices are required to be comparatively smaller, and often at the same time include greater functionality, there is a need to seek new methods, materials and devices to provide smaller more functional devices. For example, mobile phones, personal digital assistants (PDA), laptop computers, global positioning system (GPS) devices and personal video devices to name only a few require of many devices installed in these devices to be smaller.

Many such electronic devices require some type of amplification at one stage or another of the device. For example, a power amplifier (PA) is used in many stages of the electronic device. A directional coupler is used to couple a secondary transmission path to a wave travelling in one direction on a primary transmission path. The secondary transmission path normally has two ports, namely a coupled port which receives a small amount of energy from the wave on the primary transmission path, typically 10 to 20 dB less than that in the primary transmission path, and an isolated port which ideally does not receive any of the coupled energy. In order to reduce the size of the power amplifier stage of the electronic device, it is useful to incorporate the directional coupler in the package of the PA.

When a directional coupler is implemented in a power amplifier (PA) module, there are various considerations and requirements that impact the implementation of the coupler design. For example, due to the trend of minimization of the size of the PA module, the directional coupler should not add to the size of the module. Moreover, the directional coupler should provide comparatively large directivity performance for the total radiated power (TRP) control and inner loop power control. Known attempts to provide an improved coupler directivity and overall coupling often result in an unacceptable increase in the size of the PA module.

What is needed, therefore, is a PA module comprising a directional coupler that that overcomes at least the known shortcomings described above.

In accordance with a representative embodiment, a power amplifier module comprises a power amplifier disposed in a coreless substrate; and a directional coupler disposed in a coreless substrate and connected to the power amplifier.

In accordance with another representative embodiment, a power amplifier module comprises a plurality of layers of a coreless substrate; a power amplifier disposed in the coreless substrate; a directional coupler disposed in two layers of the coreless substrate and connected to the power amplifier; and a plurality of vias connecting transmission lines and the directional coupler in the coreless substrate.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 shows a simplified schematic block diagram of a power amplifier and a directional coupler in accordance with a representative embodiment.

FIG. 2 shows a simplified schematic block diagram of a power amplifier module comprising a directional coupler in accordance with a representative embodiment.

FIG. 3 shows an exploded perspective view of conductive elements of a directional coupler in accordance with a representative embodiment.

FIG. 4 shows an exploded perspective view of a multi-layer PA module in accordance with a representative embodiment.

FIG. 5 shows simplified schematic diagram of a PA module in accordance with a representative embodiment.

FIGS. 6A-6E show exploded perspective views of multi-layer PA modules in accordance with representative embodiments.

FIG. 7A shows an exploded perspective view of multi-layer PA modules in representative embodiments.

FIG. 7B shows a simplified schematic diagram of a power amplifier matching circuit in accordance with a representative embodiment.

FIGS. 8A-8B show exploded perspective views of multi-layer PA modules in representative embodiments.

### DEFINED TERMINOLOGY

It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms ‘a’, ‘an’ and ‘the’ include both singular and plural referents, unless the context clearly dictates otherwise. Thus, for example, ‘a device’ includes one device and plural devices.

As used in the specification and appended claims, and in addition to their ordinary meanings, the terms ‘substantial’ or ‘substantially’ mean to with acceptable limits or degree. For example, ‘substantially cancelled’ means that one skilled in the art would consider the cancellation to be acceptable.

As used in the specification and the appended claims and in addition to its ordinary meaning, the term ‘approximately’ means to within an acceptable limit or amount to one having ordinary skill in the art. For example, ‘approximately the same’ means that one of ordinary skill in the art would consider the items being compared to be the same.

### DETAILED DESCRIPTION

In the following detailed description, for purposes of explanation and not limitation, specific details are set forth in order to provide a thorough understanding of illustrative embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the illustrative embodiments. Such methods and apparati are clearly within the scope of the present teachings.

Generally, it is understood that the drawings and the various elements depicted therein are not drawn to scale. Further, relative terms, such as “above,” “below,” “top,” “bottom,” “upper” and “lower” are used to describe the various elements' relationships to one another, as illustrated in the accompanying drawings. It is understood that these relative terms are intended to encompass different orientations of the structure and/or elements in addition to the orientation depicted in the drawings. For example, if the structure were inverted with respect to the view in the drawings, an element described as “above” another element, for example, would now be below that element.

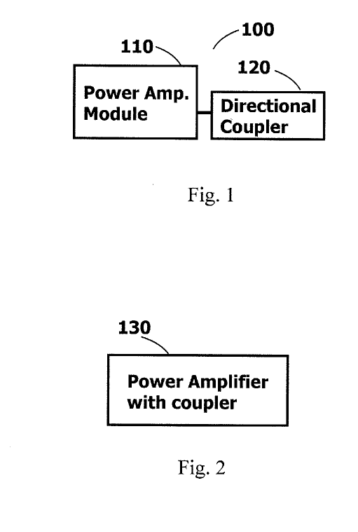

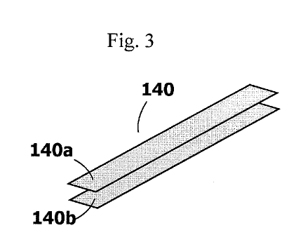

FIG. 1 shows a simplified schematic block diagram of a power amplifier module 100 comprising a power amplifier 110 and a directional coupler 120 in accordance with a representative embodiment. The power amplifier (PA) 110 may be one of a number of known PAs, and is selected based on desired features for a selected application. The directional coupler 120 is described in greater detail below, and is disposed in a coreless substrate. FIG. 2 shows a simplified schematic block diagram of a power amplifier module 130 comprising a PA and a directional coupler in accordance with a representative embodiment. Beneficially, due to the trend of minimization of module size, coupler 120 is integrated into the PA module without substantially increasing the overall physical size/dimensions of the module. Stated somewhat differently, the PA module 130 is essentially the same size as the PA 110 of FIG. 1. Moreover, the directional coupler of the PA module 130 has a comparatively high directivity for the total radiated power (TRP) control and inner loop power control. Known attempts to attain such high directivity without increasing the size of the PA module have not been useful. As described more fully below, the use of a coreless multi-layer substrate allows the desired high directivity while maintaining the desired size of the PA module.

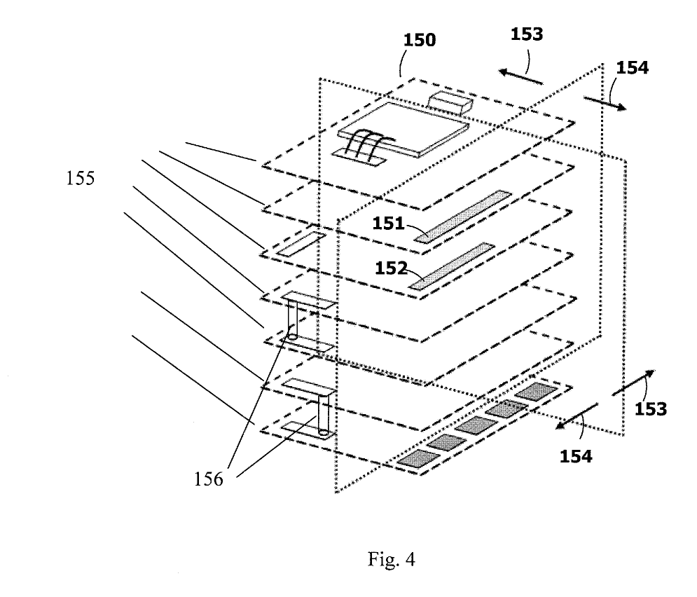

FIG. 3 shows an exploded perspective view of conductive elements of a directional coupler 140 in accordance with a representative embodiment. The directional coupler 140 is illustratively a broadside coupler separated by a comparatively small dielectric distance between adjacent layers, according sufficient coupling within very small size. The directional coupler 140 includes a through line 140a and coupled line 140b overlapping the through line 140a with a dielectric material. As described more fully herein, the integrated directional coupler is usefully connected to the PA and bottom pads of module (not shown in FIG. 3) in a rather limited area. Therefore, it is useful to place vias for various connections with design flexibility. As described more fully herein, this flexibility in via placement, or via stacking, includes the use of a multi-layer substrate comprising a plurality of coreless substrates fosters via stacking while maintaining coupler performance. Moreover, coreless substrates accord flexibility in selecting the dielectric distance between adjacent metal layers. Coreless substrate, which contains no core, may be made of relatively rigid glass epoxy. The coreless substrate may include a build-up substrate (SLC substrate) composed of an insulating layer and patterned conductor layer alternately stacked. Thus, patterned conductive layers may be used to form lines 140a, 140b of the directional coupler 140, with a layer of dielectric of selected material and thickness for the desired dielectric distance between the lines 140a, 140b.

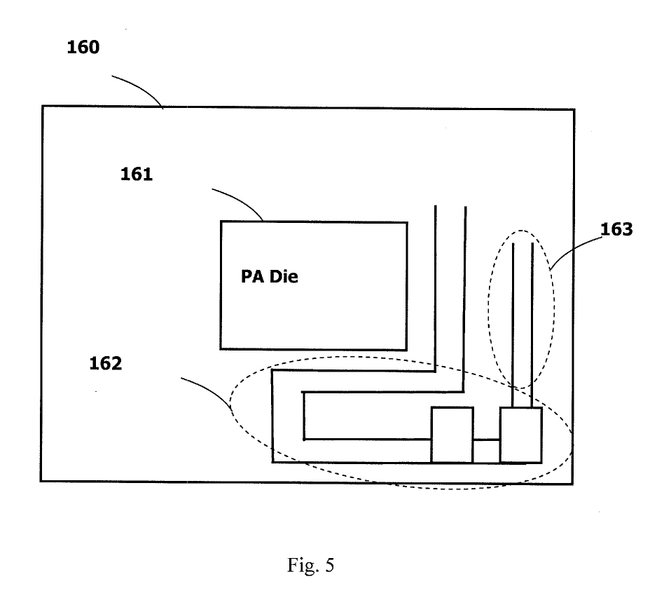

FIG. 4 shows an exploded perspective view of a multi-layer PA module 150 in accordance with a representative embodiment. The PA module 150 comprises a plurality of layers 155, where each layer 155 is a pattern layer of coreless substrate. In the representative embodiment, there are seven layers that provide an effective pattern layers for the module comprising a PA with an integrated directional coupler comprising transmission lines 151, 152, each embedded in a respective layer 155. Notably, broadside coupler lines 151, 152 are disposed in a multi-layer substrate comprising a dielectric material of suitable thickness to provide the desired dielectric thickness for the directional coupler. In FIG. 4, arrow 153 signifies the portion of the PA module 150 comprising the components of the PA, and arrow 154 shows that the transmission lines 151, 152 of the coupler are positioned in a comparatively small portion of the module 150 to maintain a comparatively small physical size. The interconnections between layers 155 may be made with vias 156.

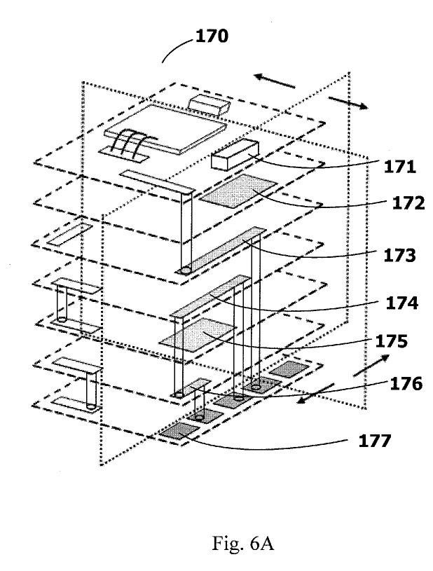

FIG. 5 shows simplified schematic diagram of a PA module 160 in accordance with a representative embodiment. Many of the details of the PA module 160 are common to the embodiments described above, and generally are not repeated to avoid obscuring the presently described embodiments. In PA module 160 comprising a directional coupler, in addition to providing suitable coupler directivity, it is beneficial to provide sufficient isolation of the directional coupler from other circuits and components of the PA module 160 and other circuits of the electronic device including the PA module. For example, directional coupler 163 is embedded in PA module 160 without impacting the overall size of the module. However, the directional coupler is located comparatively close to the power amplifier chip 161 and an impedance matching circuit 162 due to the size limitation. If undesired signal coupling (e.g., cross-talk) from power amplifier chip 161, or the impedance matching circuit 162, or both, are coupled to the coupled line of the directional coupler 163, such coupling could have a deleterious impact on performance of the PA module 160. For example, the coupled power at the output port of the module 160 can be more sensitive to phase sweep of load VSWR. As should be appreciated, this is equivalent to comparatively poor coupler directivity. For this reason, the structure of the directional coupler 163 is selected to provide comparatively good isolation between a coupled line of coupler 163 and other circuits is required. In accordance with a representative embodiment, a broadside coupler (e.g., directional coupler 140) provides sufficient isolation in which the through line (e.g., transmission line 140a) is placed in an upper layer compared to the coupled line (e.g., transmission line 140b), so the through line can provide block unwanted signals such as from the power amplifier chip 161, or the impedance matching circuit 162, which are coupled to the coupled line of directional coupler 163.

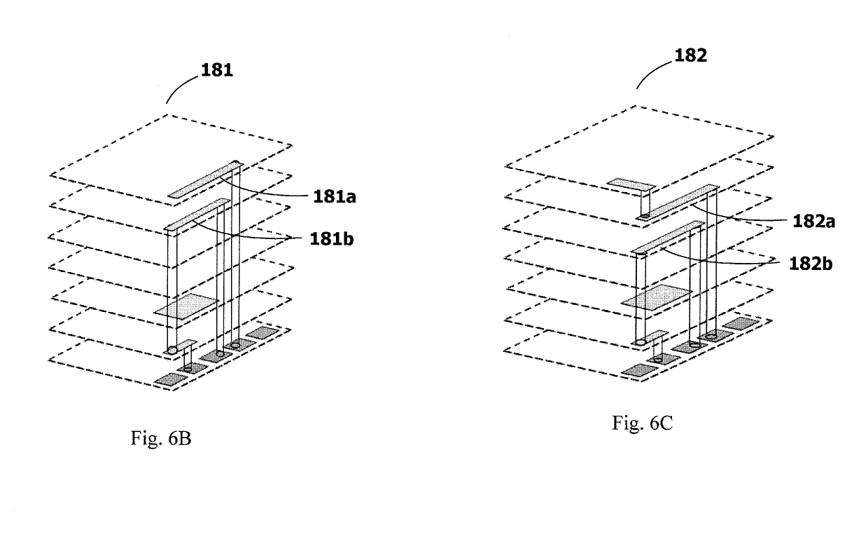

FIGS. 6A-6E show exploded perspective view of multi-layer PA modules in accordance with representative embodiments. Many of the details of the PA modules of FIGS. 6A-6C are common to the embodiments described above, and generally are not repeated to avoid obscuring the presently described embodiments. For the integration of a directional coupler in the limited area of PA module in accordance with a representative embodiment, a sufficient pattern layer number of coreless substrate is required. FIG. 6A shows sufficient pattern layer number of module substrate. A top layer of the multilayer substrate of the PA module 170 may be used for mounting of other surface mount devices (SMDs) 171. Another layer may provide for RF blocking between mounted SMD and a directional coupler structure 172. Notably, two layers are provided for transmission lines 173, 174 of a directional coupler, which is illustratively a broadside coupler. One layer is used for RF blocking between directional coupler and pads disposed on a layer beneath the transmission lines 173, 174, or impedance optimization of coupler lines, or both 175. Another layer is used for a connection line between the directional coupler and bottom pads 176. A bottom layer is used for bottom connection pads 177 of module. In this way, seven pattern layers supply sufficient pattern layer number for integration of directional coupler in the extremely limited area of module which is practically in the edge side of module. Notably, and as illustrated, vias suitable for inter-layer connection provide the connection between components on differing layers of the multilayer substrate. Directivity of broadside coupler is related to widths of coupler lines 173, 174. Pattern on a layer beneath the transmission lines 175 is also related to directivity. By selection of optimized line widths of coupler lines 173, 174 and pattern (175) optimization on a layer beneath transmission lines, appropriate directivity can be achieved about over 20 dB.

As shown in FIGS. 6B and 6C in connection with module 181, 182, respectively, if fewer components are required, greater freedom in placement of components is provided. For example, seven components are implemented in the module. If fewer components are required, coupler lines can be assigned to other layers with freedom of layer selection. For example, if SMD mounting is not required, RF blocking between a mounted SMD and the directional coupler is not required. As such, coupler lines can be implemented in the selected two layers among layers 181a, 181b in module 181 and among two layers 182a, 182b in module 182. Therefore, coreless seven-layer substrate structure enables the implementation of a high performance directional coupler in a limited area of power amplifier module with limited module size with the freedom of coupler design. In a representative embodiment, seven pattern layers supply a sufficient pattern layer number for integration of directional coupler in a comparatively limited area of the PA module as described above.

FIGS. 6D and 6E show the implementation of modules 191, 192, respectively, comprising fewer than seven layers of a coreless substrate. Notably, module 191 comprises a multi-layer substrate comprising six layers, and module 192 comprises a multi-layer substrate comprising five layers.

Performance of the power amplifier module comprising a directional coupler of the present teachings not only may depend on the directivity of the directional couplers integrated therein, but also may depend the coupled power accuracy over phase sweep of load VSWR in the combination of power amplifier and coupler. In accordance with representative embodiments, suitable coupled power over phase sweep of load VSWR is attained by optimizing the impedance of the power amplifier output matching to enhance coupled power accuracy with given coupler directivity.

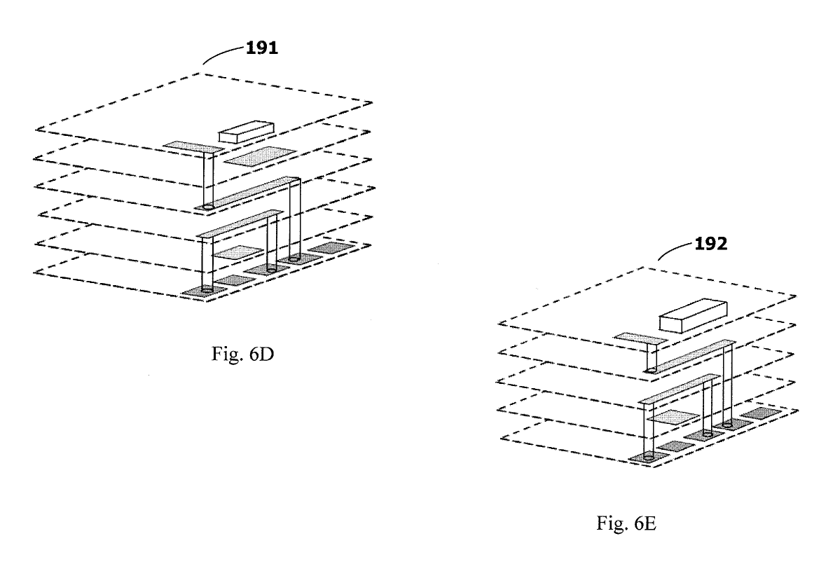

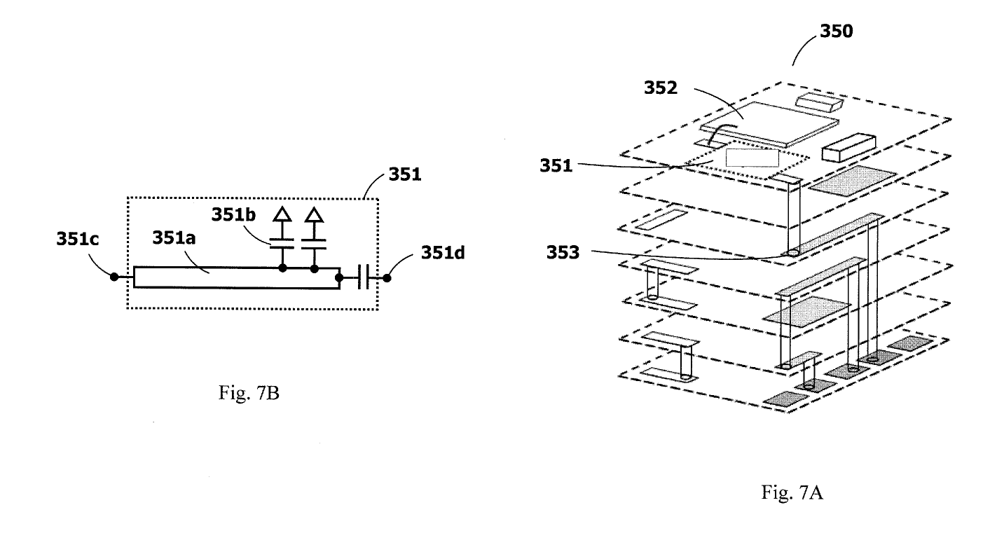

FIG. 7A shows a PA module 350 comprising a directional coupler 353 that is followed by an output impedance matching circuit 351 of the power amplifier in accordance with a representative embodiment. As shown in detail in FIG. 7B, power amplifier output matching circuit 351 can be illustratively realized using an RF transmission line 351a and capacitors 351b and placed between power amplifier 351c and input of coupler through line 351d. One implementation for accurate coupled power is a single module embodiment with optimal power amplifier output matching to maximize accuracy of coupled power over phase sweep of load VSWR with given inherent coupler directivity. If a discrete power amplifier (e.g., 110) and discrete coupler 120 are used, optimal output matching impedance of power amplifier to enhance coupled power accuracy with given discrete coupler is not achievable because discrete power amplifier is developed independent of coupler. Single module embodiment of a power amplifier and coupler on a multilayer (e.g., 5, 6 or 7 layer) coreless substrate with effective coupler structure as described above can achieve accurate coupled power over phase sweep of load VSWR, because it is possible not only to achieve required directivity of embedded coupler itself with effective substrate structure and effective coupler structure, but also to achieve optimal power amplifier output matching impedance most properly fitted to given coupler.

A comparatively high coupling coupler or a comparatively low frequency coupler require long physical line length for sufficient overlap between through line and coupled line of coupler. Generally, coupler with bended line has poor directivity compared to straight line coupler. So, a structure is required for minimizing the degradation of directivity performance in high coupling coupler or low frequency coupler implementation.

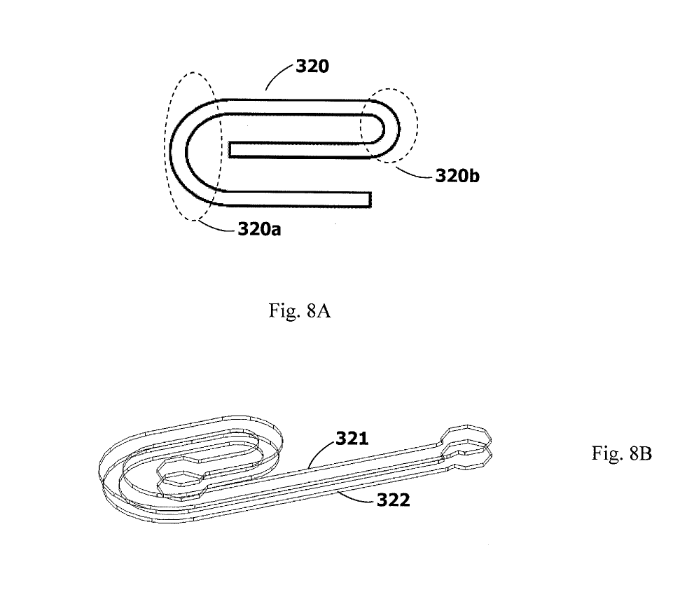

FIGS. 8A and 8B show semi-spiral type broadside couplers 320, 321, 322 with half circle bends 320a, 320b in accordance with a representative embodiment. Beneficially, the half-circle bends 320a, 320b in the transmission lines foster improved coupling within small area minimizing directivity degradation. Notably, the semi-spiral shape is merely illustrative, and other shapes are contemplated to provide improved coupling in a smaller areal dimension are contemplated. For example, a directional coupler having comparatively low coupling or a comparatively high frequency coupler which requires only short physical line length is realized using short straight lines 140 which include through line 140a and coupled line 140b overlapping the through line 140a with a dielectric material. In a same manner, comparatively high coupling or a low frequency coupler can be realized using semi-spiral type lines with half-circle bending shape which include semi-spiral through line 321 and semi-spiral coupled line 322 overlapping the semi-spiral through line 321 with a dielectric material.

One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A power amplifier module, comprising:
a power amplifier disposed in a coreless substrate; and
a directional coupler disposed in the coreless substrate and connected to the power amplifier.

2. A power amplifier module as claimed in claim 1, wherein substrate structure is a multi-layer coreless substrate.

3. A power amplifier module as claimed in claim 1, further comprising an output matching circuit comprising a transmission line and capacitors, wherein the output impedance matching circuit is provided between the power amplifier and an input of a coupler through line.

4. A power amplifier module as claimed in claim 2, wherein the directional coupler is integrated in the power amplifier module, and the power amplifier module further comprises transmission lines disposed in two layers of the coreless substrate.

5. A power amplifier module as claimed in claim 4, wherein the directional coupler comprises a broadside coupler.

6. A power amplifier module as claimed in claim 5, wherein a through line of the broadside coupler is disposed in an upper layer of the multi-layer coreless substrate and a coupled line of the broadside coupler is disposed in a lower layer of the multi-layer coreless substrate.

7. A power amplifier module as claimed in claim 1, wherein the coreless substrate comprised a top layer and a surface mount device is disposed over the top layer.

8. A power amplifier module as claimed in claim 1, wherein the directional coupler comprises a half-circle portion.

9. A power amplifier module as claimed in claim 8, wherein the directional coupler comprises another half-circle portion disposed over the half-circle portion.

10. A power amplifier module, comprising:
a plurality of layers of a coreless substrate;
a power amplifier disposed in the coreless substrate;
a directional coupler disposed in two layers of the coreless substrate and connected to the power amplifier; and
a plurality of vias connecting respective transmission lines and the directional coupler in the coreless substrate.

11. A power amplifier module as claimed in claim 10, wherein the coreless substrate comprises a seven layer coreless substrate and seven patterned layers.

12. A power amplifier module as claimed in claim 10, wherein the coreless substrate comprises a sic layer coreless substrate and six patterned layers.

13. A power amplifier module as claimed in claim 10, wherein the coreless substrate comprises a five layer coreless substrate and five patterned layers.

14. A power amplifier module as claimed in claim 10, further comprising an output matching circuit comprising a transmission line and capacitors, wherein the output impedance matching circuit is provided between the power amplifier and an input of a coupler through line.

15. A power amplifier module as claimed in claim 10, wherein the directional coupler is integrated in the module, and the power amplifier module further comprises transmission lines disposed in two layers of the coreless substrate.

16. A power amplifier module as claimed in claim 15, wherein the directional coupler comprises a broadside coupler.

17. A power amplifier module as claimed in claim 16, wherein a through line of the broadside coupler is disposed in an upper layer of the coreless substrate and a coupled line of the broadside coupler is disposed in a lower layer of coreless substrate.

18. A power amplifier module as claimed in claim 10, wherein a top layer of the coreless substrate comprises a surface mount device disposed thereover.

19. A power amplifier module as claimed in claim 10, wherein the directional coupler comprises a half-circle portion.

20. A power amplifier module as claimed in claim 19, wherein the directional coupler comprises another half-circle portion disposed over the half-circle portion.
